(19) United States
(12) Patent Application Publication
(10) Pub. No.: US 2007/0250311 A1
(43) Pub. Date: Oct. 25, 2007

(54) Method and apparatus for automatic adjustment of play speed of audio data

(76) Inventor: Glen Shires, Danville, CA (US)

Correspondence Address: Lawrence Cho;C/O PortfolioIP, P.O. Box 52050, Minneapolis, MN, 55402, US

(21) Appl. No.: 11/411,074

(22) Filed: Apr. 25, 2006

(51) Int. Cl. G10L 21/02

(52) U.S. Cl. 704/226

(57) ABSTRACT

A method for managing audio data includes identifying a condition in the audio data. A rate of playback of the audio data is automatically adjusted in response to identifying the condition. Other embodiments are disclosed.

### TECHNICAL FIELD

Embodiments of the present invention pertain to media players that play audio data. More specifically, embodiments of the present invention relate to a method and apparatus for automatic adjustment of play speed of audio data.

### BACKGROUND

Media players exist with features that allow recordings of audio and audio-video sessions to be played at a rate that is faster than the normal rate. This permits users to listen or watch these sessions over a shorter period of time. Usage of these features may be common in business applications, for example, where employees view and/or listen to training sessions, meetings, conferences, and presentations. Usage of these features may also be common in entertainment applications, for example, where users listen to radio or podcasts, or watch television. These features allow faster playback to be free of audio and video glitches.

Typically, users find playback of audio data to be intelligible and comprehensible at playback rates roughly between 1.2 to 1.9 times the normal playback rate. The optimal rate, however, may vary during playback due to the rate of speech of a speaker, background noise, the presence of silence or filled pauses, and other criteria that may change during the course of playback of the audio data.

Current media players allow for users to manually adjust the playback rate of audio data. When the optimal rate of playback changes frequently during the course of playing back audio data, making adjustments manually may be inconvenient. Furthermore, when making manual adjustment, a listener may only react to changes in the audio data. The delay experienced in detecting and reacting to the change in audio data may result in playing back portions of audio data at a rate that is incomprehensible to the listener. This may cause the listener to replay the audio data and thus negate some of the benefits of faster playback.

### BRIEF DESCRIPTION OF THE DRAWINGS

The features and advantages of embodiments of the present invention are illustrated by way of example and are not intended to limit the scope of the embodiments of the present invention to the particular embodiments shown.

FIG. 1 is a block diagram of an exemplary system in which an example embodiment of the present invention may be implemented on.

FIG. 2 is a block diagram of a play-speed adjustment unit according to an example embodiment of the present invention.

FIG. 3 is a block diagram of a rate of change integrator unit according to an example embodiment of the present invention.

FIG. 4 is a flow chart illustrating a method for managing audio data according to a first embodiment of the present invention.

FIG. 5 is a flow chart illustrating a method for managing audio data according to a second embodiment of the present invention.

FIG. 6 is a flow chart illustrating a method for generating a play-speed control value according to an embodiment of the present invention.

### DETAILED DESCRIPTION

In the following description, for purposes of explanation, specific nomenclature is set forth to provide a thorough understanding of embodiments of the present invention. However, it will be apparent to one skilled in the art that these specific details may not be required to practice the embodiments of the present invention. In other instances, well-known circuits, devices, and procedures are shown in block diagram form to avoid obscuring embodiments of the present invention unnecessarily.

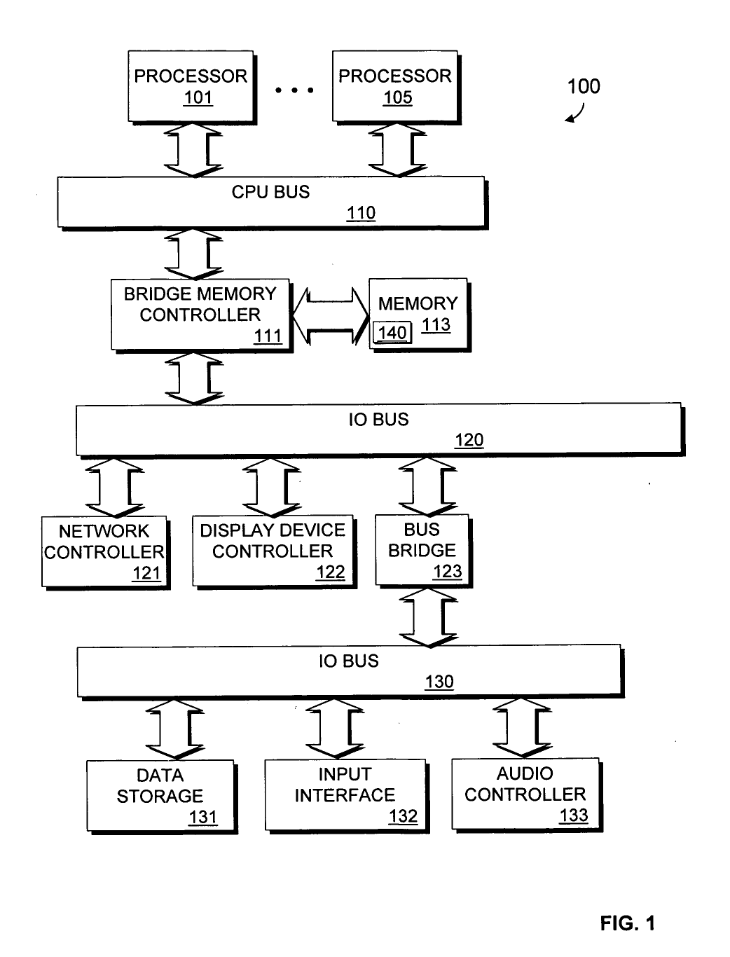

FIG. 1 is a block diagram of a first embodiment of a system in which an embodiment of the present invention may be implemented on. The system is a computer system 100. The computer system 100 includes one or more processors that process data signals. As shown, the computer system 100 includes a first processor 101 and an nth processor 105, where n may be any number. The processors 101 and 105 may be complex instruction set computer microprocessors, reduced instruction set computing microprocessors, very long instruction word microprocessors, processors implementing a combination of instruction sets, or other processor devices. The processors 101 and 105 may be multi-core processors with multiple processor cores on each chip. The processors 101 and 105 are coupled to a CPU bus 110 that transmits data signals between processors 101 and 105 and other components in the computer system 100.

The computer system 100 includes a memory 113. The memory 113 includes a main memory that may be a dynamic random access memory (DRAM) device. The memory 113 may store instructions and code represented by data signals that may be executed by the processors 101 and 105. A cache memory (processor cache) may reside inside each of the processors 101 and 105 to store data signals from memory 113. The cache may speed up memory accesses by the processors 101 and 105 by taking advantage of its locality of access. In an alternate embodiment of the computer system 100, the cache may reside external to the processors 101 and 105.

A bridge memory controller 111 is coupled to the CPU bus 110 and the memory 113. The bridge memory controller 111 directs data signals between the processors 101 and 105, the memory 113, and other components in the computer system 100 and bridges the data signals between the CPU bus 110, the memory 113, and a first input output (IO) bus 120.

The first IO bus 120 may be a single bus or a combination of multiple buses. The first IO bus 120 provides communication links between components in the computer system 100. A network controller 121 is coupled to the first IO bus 120. The network controller 121 may link the computer system 100 to a network of computers (not shown) and supports communication among the machines. A display device controller 122 is coupled to the first IO bus 120. The display device controller 122 allows coupling of a display device (not shown) to the computer system 100 and acts as an interface between the display device and the computer system 100.

A second IO bus 130 may be a single bus or a combination of multiple buses. The second IO bus 130 provides communication links between components in the computer system 100. Data storage device 131 is coupled to the second IO bus 130. The data storage 131 may be a hard disk drive, a floppy disk drive, a CD-ROM device, a flash memory device or other mass storage device. An input interface 132 is coupled to the second IO bus 130. The input interface 132 may be, for example, a keyboard and/or mouse controller or other input interface. The input interface 132 may be a dedicated device or can reside in another device such as a bus controller or other controller. The input interface 132 allows coupling of an input device to the computer system 100 and transmits data signals from an input device to the computer system 100. An audio controller 133 is coupled to the second IO bus 130. The audio controller 133 operates to coordinate the recording and playing of sounds. A bus bridge 123 couples the first IO bus 120 to the second IO bus 130. The bus bridge 123 operates to buffer and bridge data signals between the first IO bus 120 and the second IO bus 130.

According to an embodiment of the present invention, a play-speed adjustment unit 140 may be implemented on the computer system 100. According to one embodiment, audio data management is performed by the computer system 100 in response to the processor 101 executing sequences of instructions in the memory 113 represented by the play-speed adjustment unit 140. Such instructions may be read into the memory 113 from other computer-readable mediums such as data storage 131 or from a computer connected to the network via the network controller 112. Execution of the sequences of instructions in the memory 113 causes the processor to support management of audio data. According to an embodiment of the present invention, the play-speed adjustment unit 140 identifies a condition in audio data. The play-speed adjustment unit 140 automatically adjusts a rate of playback of the audio data in response to identifying the condition. The condition may be, for example, a rate of speech, background noise, a filled pause, or other condition.

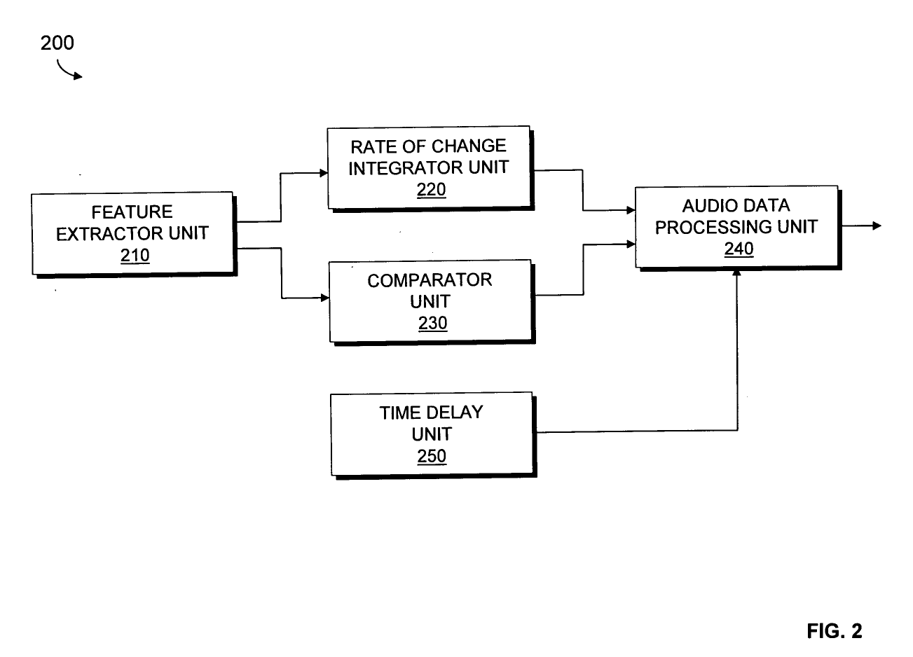

FIG. 2 is a block diagram of a play-speed adjustment unit 200 according to an example embodiment of the present invention. The play-speed adjustment unit 200 may be used to implement the play-speed adjustment unit 140 shown in FIG. 1. It should be appreciated that the play-speed adjustment unit 200 may reside in other types of systems. The play-speed adjustment unit 200 includes a plurality of modules that may be implemented in software. In alternative embodiments, hard-wire circuitry may be used in place of or in combination with software to perform audio data management. Thus, the embodiments of the present invention are not limited to any specific combination of hardware circuitry and software.

The play-speed adjustment unit 200 includes a feature extractor unit 210. The feature extractor unit 210 extracts features from audio data it receives. According to an embodiment of the present invention, the feature extractor unit 210 transforms the audio data from a time domain to a frequency domain and identifies features in the frequency domain. In one embodiment, the features may be based on sub-band energies. In this embodiment, the features may be identified using Mel-Frequency Cepstral Coefficients or by using other techniques or procedures. According to an alternate embodiment, the features may be based on phoneme characteristics. In this embodiment, phoneme characteristics may be identified by pattern matching or pattern classification against reference speech signals, using a hidden Markov model, Viterbi alignment or dynamic time warping, or by using other techniques or procedures. It should be appreciated that the features may be based on other properties and identified using other techniques.

The play-speed adjustment unit 200 includes a rate of change integrator unit 220. The rate of change integrator unit 220 recognizes a condition where the audio data includes speech being produced at a rate that has changed. According to one embodiment, the rate of change integrator unit 220 produces an output that corresponds to the rate of change, averaged over time, of the features from unit 210. The rate of change integrator 220 may generate a play-speed control value that may be used to adjust the playback rate of the audio data. According to an embodiment where the features are based on sub-band energies, the rate of change integrator unit 220 may measure a difference between consecutive samples of a feature. By taking an average of the measurements from a plurality of features, an overall rate of change of the features is identified. The rate of change may be used to determine a rate of change of speech and an appropriate play-speed control value to generate. According to an embodiment where the features are based on phonemes, the rate of change of the phoneme classifications may be averaged over time to generate an appropriate play-speed control value.

The play-speed adjustment unit 200 may include a comparator unit 230. The comparator unit 230 recognizes when other conditions are present in the audio data. The comparator unit 230 may generate one or more play-speed control values that may be used to adjust the playback rate of the audio data based upon the conditions. According to an embodiment of the play-speed adjustment unit 200, the comparator unit 230 may compare the features of the audio data to features in speech models that may reflect different conditions. Features of the audio data may be compared with speech models that reflect high and low amounts of background noise to determine a degree of background noise present in the audio data and the quality of the recording. According to an embodiment of the present invention, if a large degree of background noise is present in the audio data, the comparator unit 230 generates a play-speed control value that decreases a rate of playback. Features of the audio data may be compared with speech models that reflect pauses in speech or pauses filled with expressions that do not contribute to the content of the audio data to determine whether a portion of the audio data may be sped up during playback or edited. It should be appreciated that other conditions may also similarly be detected. For example, the comparator unit 230 may generate play-speed control values to adjust the playback rate of audio data based on changes in video images.

The play-speed adjustment unit 200 includes an audio data processing unit 240. The audio data processing unit 240 receives one or more play-speed control values. When the audio data processing unit 240 receives more than one play-speed control values, it may take an average of the values, compute a weighted average of the values, or take a minimum or maximum value. The audio data processing unit 240 also receives the audio data to be played and adjusts a rate of playback of the audio data in response to the one or more play-speed control values. According to an embodiment of the present invention, the audio data processing unit 240 may adjust the rate of playback by performing selective sampling, synchronized overlap-add, harmonic scaling, or by performing other procedures or techniques.

The play-speed adjustment unit 200 may include a time delay unit 250. The time delay unit 250 delays when the audio data processing unit 240 receives the audio data. By inserting a delay, the time delay unit 250 allows the rate of change integrator unit 220 and the comparator unit 230 to analyze the features of the audio data and generate appropriate play-speed control values before the audio data is played by the audio data processing unit 240.

According to an embodiment of the play-speed adjustment unit 200, the feature extractor unit 210, rate of change integrator unit 220, comparator unit 230, audio data processing unit 240, and time delay unit 250 may be implemented using any appropriate procedure, technique, or circuitry. It should be appreciated that some of the components shown may be optional, such as the comparator unit 230 and the time delay unit 250.

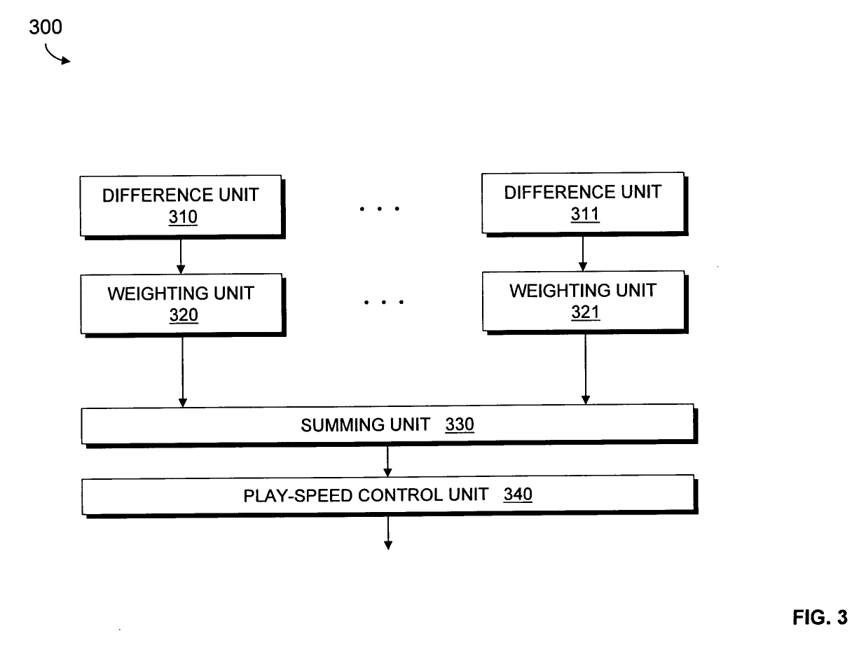

FIG. 3 is a block diagram of a rate of change integrator unit 300 according to an example embodiment of the present invention. The rate of change integrator unit 300 maybe implemented as an embodiment of the rate of change integrator unit 220 shown in FIG. 2. The rate of change integrator unit 300 includes a plurality of difference units. According to an embodiment of the rate of change integrator unit 300, a difference unit is provided for each feature type processed by the rate of change integrator unit 300. Block 310 represents a first difference unit. Block 311 represents an nth difference unit, where n can be any number. The difference units 310 and 311 compare properties of features received from a feature extractor unit from different periods of time and compute an absolute value of the difference (absolute difference value). For example, difference unit 310 may compute the absolute difference value of a feature of a first type identified at time t and a feature of the first type identified at t-1. Difference unit 311 may compute the absolute difference value of a feature of a second type identified at time t and a feature of the second type identified at t-1.

The rate of change integrator unit 300 may include a plurality of optional weighting units. According to an embodiment of the rate of change integrator unit 300, a weighting unit is provided for each feature type processed by the rate of change integrator unit 300. Block 320 represents a first weighting unit. Block 321 represents an nth weighting unit. Each weighting unit weights the absolute difference value of a feature type. The weighting units 320 and 321 may apply a weight on the absolute difference values based upon properties of the features.

The rate of change integrator unit 300 includes a summing unit 330. The summing unit 330 sums the weighted absolute difference values received by the weighting units 320 and 321.

The rate of change integrator unit 300 includes a play-speed control unit 340. The play-speed control unit 340 generates a play-speed control value from the sum of the weighted absolute difference values. According to an embodiment of the rate of change integrator unit 300, the play-speed control unit 340 takes an average of the sum of the weighted absolute difference values. According to an alternate embodiment, the play-speed control unit 340 integrates the sum of the weighted absolute difference values over a period of time.

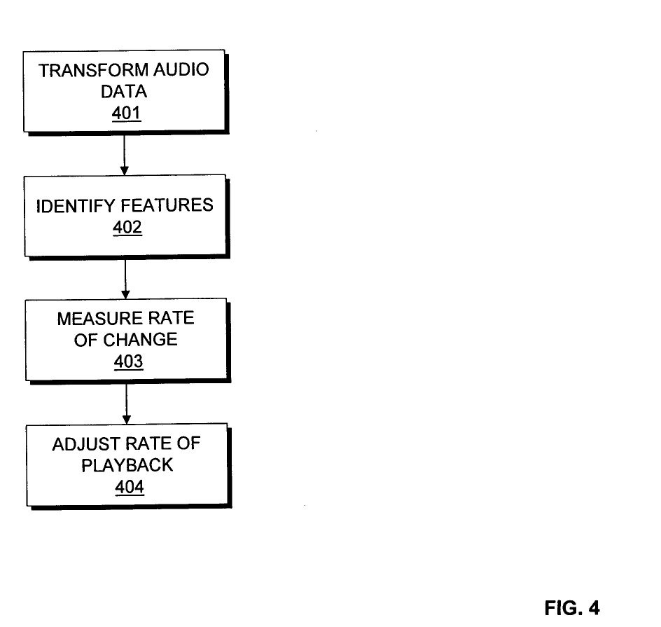

FIG. 4 is a flow chart illustrating a method for managing audio data according to a first embodiment of the present invention. At 401, the audio data is transformed from a time domain to a frequency domain. According to an embodiment of the present invention, a fast Fourier transform may be applied to the audio data to transform it from a time domain to a frequency domain.

At 402, features are identified from the audio data transformed to the frequency domain. According to an embodiment of the present invention, the features may be based on sub-band energies. In this embodiment, the features are identified using Mel-Frequency Cepstral Coefficients. According to an alternate embodiment of the present invention, the features may be based on phoneme characteristics.

At 403, a measure of the rate of change of the features is generated. According to an embodiment of the present invention, the measure of the rate of change of the features may be generated by analyzing the features of the audio data. The measure of the rate of change of the features may be used to identify a condition where a rate of speech of a speaker has changed. According to an embodiment of the present invention, a play-speed control value is generated.

At 404, a rate of playback of the audio data is adjusted. The adjustment is based upon the rate of change of the features determined at 403 as reflected by the play-speed control value. According to an embodiment of the present invention, the rate of playback of the audio may be adjusted by performing selective sampling, synchronized overlap-add, harmonic scaling, or by performing other procedures.

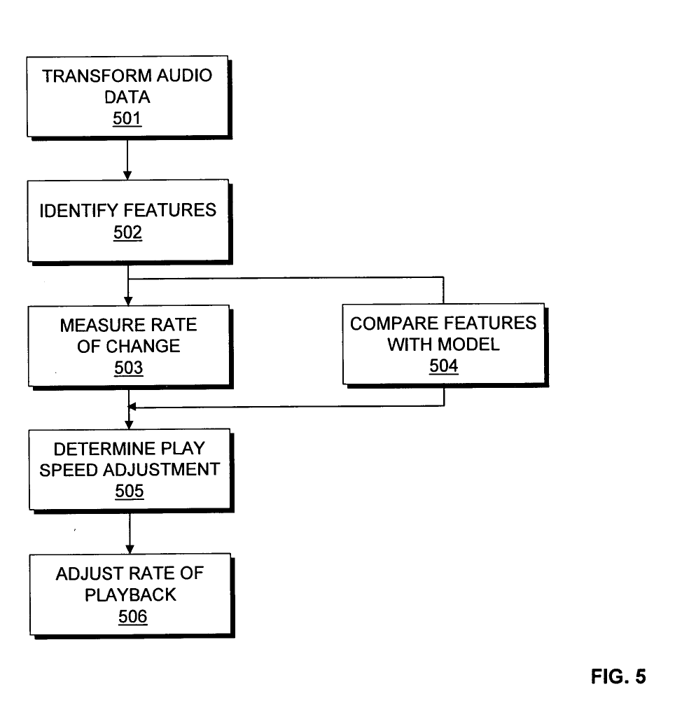

FIG. 5 is a flow chart illustrating a method for managing audio data according to a second embodiment of the present invention. At 501, the audio data is transformed from a time domain to a frequency domain. According to an embodiment of the present invention, a fast Fourier transform may be applied to the audio data to transform it from a time domain to a frequency domain.

At 502, features are identified from the audio data transformed to the frequency domain. According to an embodiment of the present invention, the features may be based on sub-band energies. In this embodiment, the features are identified using Mel-Frequency Cepstral Coefficients. According to an embodiment of the present invention, features may also be based on phoneme characteristics.

At 503, a measure of the rate of change of the features is generated. According to an embodiment of the present invention, the measure of the rate of change of the features may be generated by analyzing the features of the audio data. The measure of the rate of change of the features may be used to identify a condition where a rate of speech of a speaker has changed. According to an embodiment of the present invention, a play-speed control value is generated.

At 504, the features of the audio data identified at 502 are compared with features in speech models that reflect different conditions to determine the presence of the conditions. For example, features of the audio data may be compared with speech models that reflect high and low amounts of background noise to determine a degree of background noise present in the audio data. Features of the audio data may also be compared with speech models that reflect pauses in speech or pauses filled with expressions that do not contribute to the content of the audio data to determine whether a portion of the audio data may be sped up during playback or be edited out or omitted. It should be appreciated that other conditions may also be detected. According to an embodiment of the present invention, one or more play-speed control values are generated.

At 505, play-speed adjustment is determined from the play-speed control values generated. According to an embodiment of the present invention, the play-speed control values are averaged to determine the degree of adjustment to make on the rate of playback of the audio data. According to an alternate embodiment of the present invention, a weighted average of the play-speed control values are taken to determine the degree of adjustment to make on the rate of playback of the audio data.

At 506, a rate of playback of the audio data is adjusted. The adjustment is based upon the averaged or weighted average of the play-speed control values generated. According to an embodiment of the present invention, the rate of playback of the audio may be adjusted by performing selective sampling, synchronized overlap-add, harmonic scaling, or by performing other procedures.

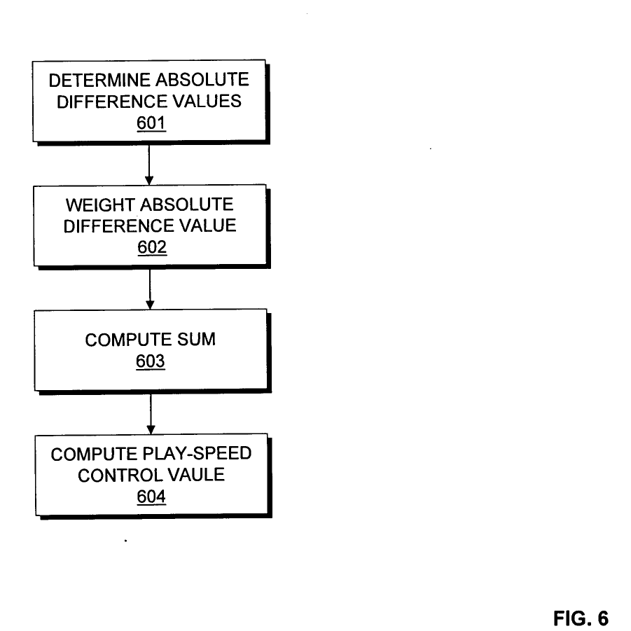

FIG. 6 is a flow chart illustrating a method for generating a play-speed control value according to an embodiment of the present invention. The method shown in FIG. 6 may be used to implement 403 and 503 shown in FIGS. 4 and 5. At 601, absolute difference values for a plurality of feature types are determined. According to an embodiment of the present invention, the absolute value is taken of the difference of each feature type measured at a first time and at a second time.

At 602, the absolute difference values of the feature types are weighted. According to an embodiment of the present invention, the absolute difference values of the feature types are weighted based upon properties of the features.

At 603, the weighted absolute difference values are summed together.

At 604, a play-speed control value is generated from the sum of the weighted absolute difference values. According to an embodiment of the present invention, an average of the sum of the weighted absolute difference values is taken. According to an alternate embodiment, the sum of the weighted absolute difference values is integrated over a period of time.

According to an embodiment of the present invention, a method for managing audio data includes identifying a condition in the audio data, and automatically adjusting a rate of playback of the audio data in response to identifying the condition. The condition may include a change in the rate speech is produced, the presence of background noise, the presence of a pause or a filled pause in speech. By automatically adjusting the rate of playback, embodiments of the present invention allow listeners to concentrate on the audio data that is being played without having to be distracted by having to manually adjust playback speed.

FIGS. 4-6 are flow charts illustrating methods according to embodiments of the present invention. Some of the techniques illustrated in these figures may be performed sequentially, in parallel, or in an order other than that which is described. It should be appreciated that not all of the techniques described are required to be performed, that additional techniques may be added, and that some of the illustrated techniques may be substituted with other techniques.

Embodiments of the present invention may be provided as a computer program product, or software, that may include an article of manufacture on a machine accessible or machine readable medium having instructions. The instructions on the machine accessible or machine readable medium may be used to program a computer system or other electronic device. The machine-readable medium may include, but is not limited to, floppy diskettes, optical disks, CD-ROMs, and magneto-optical disks or other type of media/machine-readable medium suitable for storing or transmitting electronic instructions. The techniques described herein are not limited to any particular software configuration. They may find applicability in any computing or processing environment. The terms “machine accessible medium” or “machine readable medium” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

In the foregoing specification, the embodiments of the present invention have been described with reference to specific exemplary embodiments thereof. It will, however, be evident that various modifications and changes may be made thereto without departing from the broader spirit and scope of the embodiments of the present invention. The specification and drawings are, accordingly, to be regarded in an illustrative rather than restrictive sense.

What is claimed is:

1. A method for managing audio data, comprising:
identifying a condition in the audio data; and
automatically adjusting a rate of playback of the audio data in response to identifying the condition.

2. The method of claim 1, wherein the condition is a rate of speech.

3. The method of claim 1, wherein the condition is noise.

4. The method of claim 1, wherein the condition is a filled pause.

5. The method of claim 1, wherein identifying the condition, comprises:
converting the audio data from a time domain to a frequency domain;
extracting features of the audio data in the frequency domain; and
analyzing the features of the audio data.

6. The method of claim 1, wherein identifying the condition, comprises:
converting the audio data from a time domain to a frequency domain;
extracting features of the audio data in the frequency domain; and
comparing the features of the audio data with a model.

7. The method of claim 5, wherein the features comprises sub-band energies.

8. The method of claim 5, wherein the features comprises phoneme characteristics.

9. The method of claim 1, further comprising:
identifying a second condition in the audio data; and
automatically adjusting the rate of playback of the audio data in response to identifying the first and second conditions.

10. The method of claim 1, wherein adjusting the rate of playback of the audio data comprises performing selective sampling.

11. The method of claim 1, wherein adjusting the rate of playback of the audio data comprises performing synchronized overlap-add.

12. The method of claim 1, wherein adjusting the rate of playback of the audio data comprises performing harmonic scaling.

13. An article of manufacture comprising a machine accessible medium including sequences of instructions, the sequences of instructions including instructions which when executed cause the machine to perform:
identifying a condition in audio data; and
automatically adjusting a rate of playback of the audio data in response to identifying the condition.

14. The article of manufacture of claim 13, wherein identifying the condition, comprises:
converting the audio data from a time domain to a frequency domain;
extracting features of the audio data in the frequency domain; and
analyzing the features of the audio data.

15. The article of manufacture of claim 13, further comprising instructions which when executed cause the machine to perform:
identifying a second condition in the audio data; and
automatically adjusting the rate of playback of the audio data in response to identifying the first and second conditions.

16. The article of manufacture of claim 13, wherein the condition is a rate of speech.

17. A play-speed adjustment unit, comprising:
a rate of change integrator unit to identify a change of rate of speech in audio data; and
an audio data processing unit to adjust a rate of playback of the audio data in response to the change of the rate of speech.

18. The play-speed adjustment unit of claim 17, further comprising a comparator unit to identify a condition in the audio data, wherein the audio data processing unit adjusts the rate of playback in response to the change of the rate of speech and the condition.

19. The play-speed adjustment unit of claim 17, wherein the condition is background noise.

20. The play-speed adjustment unit of claim 17, further comprising a feature extractor unit to identify features in the audio data.
